(19) United States
(12) Patent Application Publication
(10) Pub. No.: US 2013/0007672 A1
(43) Pub. Date: Jan. 3, 2013

(54) Methods and Systems for Correlating Head Movement with Items Displayed on a User Interface

(75) Inventor: Gabriel Taubman, Brooklyn, NY (US)

(73) Assignee: Google Inc., Mountain View, CA (US)

(21) Appl. No.: 13/170,949

(22) Filed: Jun. 28, 2011

(51) Int. Cl. G06F 3/033

(52) U.S. Cl. 715/863

(57) ABSTRACT

The present description discloses systems and methods for moving and selecting items in a row on a user interface in correlation with a user's head movements. One embodiment may include measuring an orientation of a user's head and communicating the measurement to a device. Next, the device can be configured to execute instructions to correlate the measurement with a shift of a row of items displayed in a user interface, and execute instructions to cause the items to move in accordance with the correlation. The device may also receive a measurement of an acceleration of the user's head movement, and can be configured to execute instructions to cause the items to move at an acceleration comparable to the measured acceleration.

### BACKGROUND

Unless otherwise indicated herein, the materials described in this section are not prior art to the claims in this application and are not admitted to be prior art by inclusion in this section.

Numerous technologies can be utilized to display information to a user of a system. Some systems for displaying information may utilize “heads-up” displays. A heads-up display is typically positioned near the user's eyes to allow the user to view displayed images or information with little or no head movement. To generate the images on the display, a computer processing system may be used. Such heads-up displays have a variety of applications, such as aviation information systems, vehicle navigation systems, and video games.

One type of heads-up display is a head-mounted display. A head-mounted display can be incorporated into a pair of glasses, a helmet, or any other item that the user wears on his or her head. Another type of heads-up display may be a projection onto a screen.

A user may desire the same functionality from a heads-up display, such as a head-mounted or projection screen display, as the user has with various other systems, such as computers and cellular phones. For example, the user may want to use a scroll feature to move through various items on the display, and the user may want to select an item from a list or row of items.

### SUMMARY

The present application discloses, inter alia, systems and methods for operating a user interface in accordance with movement and position of a user's head.

In one embodiment, a method for correlating a head movement with items displayed on a user interface is provided. The method comprises receiving a first measurement indicating a first orientation of a user's head, receiving a second measurement indicating a second orientation of a user's head, determining a movement of at least one item displayed on a user interface based on the second measurement, and causing the at least one item to move in accordance with the determination.

In yet another embodiment, an article of manufacture is provided. The article includes a tangible computer-readable media having computer-readable instructions encoded thereon. The instructions comprise receiving a first measurement indicating a first orientation of a user's head, receiving a second measurement indicating a second orientation of a user's head, determining a movement of at least one item displayed on a user interface based on a received measurement indicating the second orientation of a user's head, and causing the at least one item to move in accordance with the determination.

In yet another embodiment, a system is provided. The system comprises a processor, at least one sensor, data storage, and machine language instructions stored on the data storage executable by the processor. The machine language instructions are configured to receive a first measurement from the at least one sensor indicating a first orientation of a user's head, receive a second measurement from the at least one sensor indicating a second orientation of a user's head, determine a movement of at least one item displayed on a user interface based on the second measurement, and cause the at least one item to move in accordance with the determination.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

In the Figures:

FIG. 1A is a schematic drawing of a computer network infrastructure according to an example embodiment of the present application;

FIG. 1B is a schematic drawing of a computer network infrastructure according to an example embodiment of the present application;

FIG. 1C is a functional block diagram illustrating an example device;

FIG. 2 illustrates an example system for receiving, transmitting, and displaying data;

FIG. 3 illustrates an alternate view of the system of FIG. 2;

FIG. 4 is a flowchart of an illustrative method for communicating a user's head movement with a user interface in accordance with one aspect of the present application;

FIG. 5 is a flowchart of an illustrative method for communicating a user's head movement with a user interface in accordance with one aspect of the application;

FIG. 6A is an example user interface of a device in a first position;

FIG. 6B is the example user interface of the device of FIG. 6A in a second position;

FIG. 6C is the example user interface of the device of FIG. 6A in an alternative second position;

FIG. 7 is a functional block diagram illustrating an example computing device; and

FIG. 8 is a schematic illustrating a conceptual partial view of an example computer program,

all arranged in accordance with at teas some embodiments of the present disclosure.

### DETAILED DESCRIPTION

The following detailed description describes various features and functions of the disclosed systems and methods with reference to the accompanying figures. In the figures, similar symbols typically identify similar components, unless context dictates otherwise. The illustrative system and method embodiments described herein are not meant to be limiting. It will be readily understood that certain aspects of the disclosed systems and methods can be arranged and combined in a wide variety of different configurations, all of which are contemplated herein.

1. Overview of Systems for the Display of Items on a User Interface

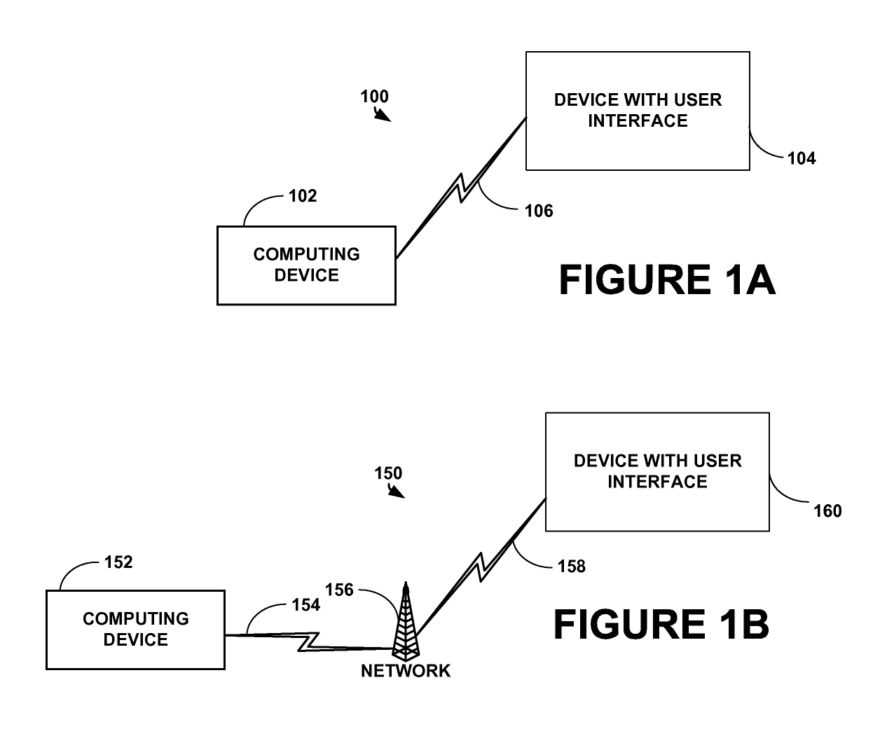

FIG. 1A is a schematic drawing of a computer network infrastructure according to an example embodiment of the present application. In one system 100, a device with a user interface 104 is coupled to a computing device 102 with a communication link 106. The device with user interface 104 may contain hardware to enable a wireless communication link. The computing device 102 may be a desktop computer, a television device, or a portable electronic device such as a laptop computer or cellular phone, for example. The communication link 106 may be used to transfer image or textual data to the user interface 104 or may be used to transfer unprocessed data, for example.

The device with user interface 104 may be a head-mounted display, such as a pair of glasses or other helmet-type device that is worn on a user's head. Sensors may be included on the device 104. Such sensors may include a gyroscope or an accelerometer. Further details of the device 104 are described herein, with reference to FIGS. 1C and 2-3, for example.

Additionally, the communication link 106 connecting the computing device 102 with the device with user interface 104 may be one of many communication technologies. For example, the communication link 106 may be a wired link via a serial bus such as USB, or a parallel bus. A wired connection may be a proprietary connection as well. The communication link 106 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities.

FIG. 1B is a schematic drawing of a computer network infrastructure according to an example embodiment of the present application. In the system 150, a computing device 152 is coupled to a network 156 via a first communication link 154. The network 156 may be coupled to a device with user interface 160 via a second communication link 158. The user interface 160 may contain hardware to enable a wireless communication link. The first communication link 154 may be used to transfer image data to the network 156 or may transfer unprocessed data. The device with user interface 160 may contain a processor to compute the displayed images based on received data.

Although the communication link 154 is illustrated as a wireless connection, wired connections may also be used. For example, the communication link 154 may be a wired link via a serial bus such as a universal serial bus or a parallel bus. A wired connection may be a proprietary connection as well. The communication link 154 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. Additionally, the network 156 may provide the second communication link 158 by a different radio frequency based network, and may be any communication link of sufficient bandwidth to transfer images or data, for example.

The systems 100 or 150 may be configured to receive data corresponding to an image. The data received may be a computer image file, a computer video file, an encoded video or data stream, three-dimensional rendering data, or openGL data for rendering. In some embodiments, the data may also be sent as plain text. The text could be rendered into objects or the system could translate the text into objects. To render an image, the system 100 or 150 may process and write information associated with the image to a data file before presenting for display, for example.

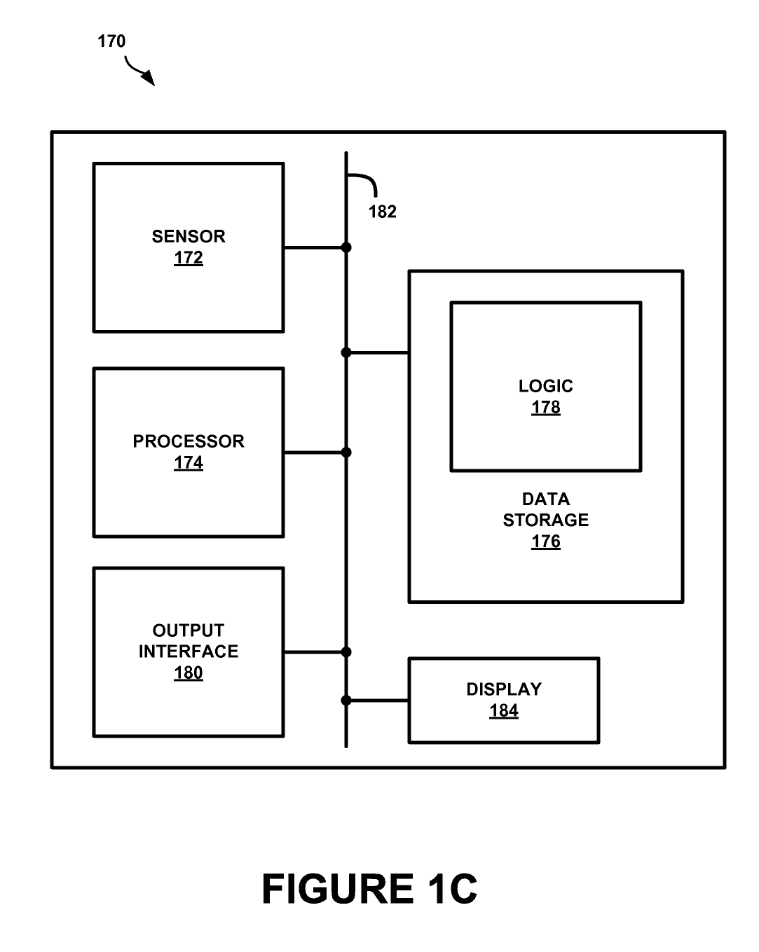

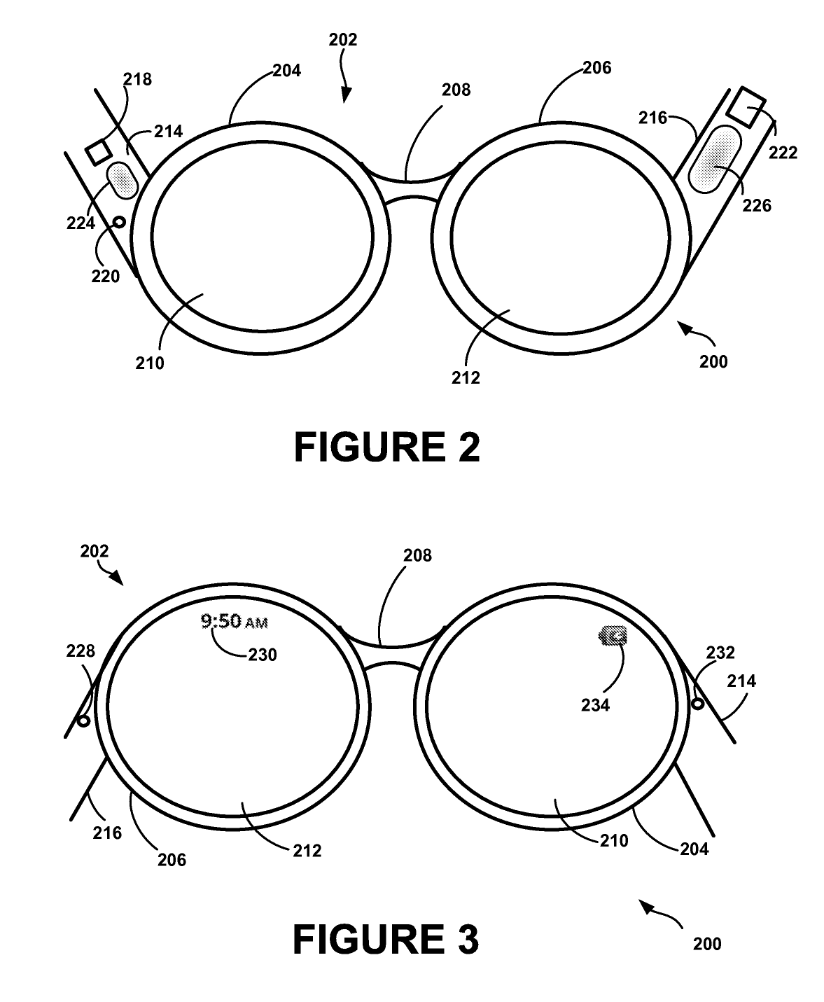

FIG. 1C is a functional block diagram illustrating an example device 170. In one example, the device 104 in FIG. 1A or the device 160 in FIG. 1B may take the form of the device shown in FIG. 1C. The device 170 may be a wearable computing device, such as a pair of goggles or glasses, as shown in FIGS. 2-3. However, other examples of devices may be contemplated.

As shown, device 170 comprises a sensor 172, a processor 174, data storage 176 storing logic 178, an output interface 180, and a display 184. The elements of the device 170 are shown coupled by a system bus or other mechanism 182.

Each of the sensor 172, the processor 174, the data storage 176, the logic 178, the output interface 180, and the display 184 are shown to be integrated within the device 170, however, the device 170 may, in some embodiments, comprise multiple devices among which the elements of device 170 are distributed. For example, sensor 172 may be separate from (but communicatively connected to) the remaining elements of device 170, or sensor 172, processor 174, output interface 180, and display 184 may be integrated into a first device, while data storage 176 and the logic 178 may be integrated into a second device that is communicatively coupled to the first device. Other examples are possible as well.

Sensor 172 may be a gyroscope or an accelerometer, and may be configured to determine and measure an orientation and/or an acceleration of the device 170.

Processor 174 may be or may include one or more general-purpose processors and/or dedicated processors, and may be configured to compute displayed images based on received data. The processor 174 may be configured to perform an analysis on the orientation, movement, or acceleration determined by the sensor 172 so as to produce an output.

In one example, the logic 178 may be executed by the processor 174 to perform functions of a graphical user interface (GUI). The GUI, or other type of interface, may include items, such as graphical icons on a display. The items may correspond to application icons, wherein if a user selects a particular icon, an application represented by that icon will appear on the user interface. Thus, when an icon is selected, instructions are executed by processor 174 to perform functions that include running a program or displaying an application, for example. The processor 174 may thus be configured to cause the items to move based on the movements of the device 170. In this example, the processor 174 may correlate movement of the device 170 with movement of the items.

The output interface 180 may be configured to transmit the output to display 184. To this end, the output interface 180 may be communicatively coupled to the display 184 through a wired or wireless link. Upon receiving the output from the output interface 180, the display 184 may display the output to a user.

In some embodiments, the device 170 may also include a power supply, such as a battery pack or power adapter. In one embodiment, the device 170 may be tethered to a power supply through a wired or wireless link. Other examples are possible as well. The device 170 may include elements instead of and/or in addition to those shown.

FIG. 2 illustrates an example device 200 for receiving, transmitting, and displaying data. The device 200 is shown in the form of a wearable computing device, and may serve as the devices 104 or 160 of FIGS. 1A and 1B. While FIG. 2 illustrates eyeglasses 202 as an example of a wearable computing device, other types of wearable computing devices could additionally or alternatively be used. As illustrated in FIG. 2, the eyeglasses 202 comprise frame elements including lens-frames 204 and 206 and a center frame support 208, lens elements 210 and 212, and extending side-arms 214 and 216. The center frame support 208 and the extending side-arms 214 and 216 are configured to secure the eyeglasses 202 to a user's face via a user's nose and ears, respectively. Each of the frame elements 204, 206, and 208 and the extending side-arms 214 and 216 may be formed of a solid structure of plastic or metal, or may be formed of a hollow structure of similar material so as to allow wiring and component interconnects to be internally routed through the eyeglasses 202. Each of the lens elements 210 and 212 may be formed of any material that can suitably display a projected image or graphic. Each of the lens elements 210 and 212 may also be sufficiently transparent to allow a user to see through the lens element. Combining these two features of the lens elements can facilitate an augmented reality or heads-up display where the projected image or graphic is superimposed over a real-world view as perceived by the user through the lens elements.

The extending side-arms 214 and 216 are each projections that extend away from the frame elements 204 and 206, respectively, and are positioned behind a user's ears to secure the eyeglasses 202 to the user. The extending side-arms 214 and 216 may further secure the eyeglasses 202 to the user by extending around a rear portion of the user's head. Additionally or alternatively, for example, the device 200 may connect to or be affixed within a head-mounted helmet structure. Other possibilities exist as well.

The device 200 may also include an on-board computing system 218, a video camera 220, a sensor 222, and finger-operable touch pads 224, 226. The on-board computing system 218 is shown to be positioned on the extending side-arm 214 of the eyeglasses 202; however, the on-board computing system 218 may be provided on other parts of the eyeglasses 202. The on-board computing system 218 may include a processor and memory, for example. The on-board computing system 218 may be configured to receive and analyze data from the video camera 220 and the finger-operable touch pads 224, 226 (and possibly from other sensory devices, user interfaces, or both) and generate images for output from the lens elements 210 and 212.

The video camera 220 is shown to be positioned on the extending side-arm 214 of the eyeglasses 202; however, the video camera 220 may be provided on other parts of the eyeglasses 202. The video camera 220 may be configured to capture images at various resolutions or at different frame rates. Many video cameras with a small form-factor, such as those used in cell phones or webcams, for example, may be incorporated into an example of the device 200. Although FIG. 2 illustrates one video camera 220, more video cameras may be used, and each may be configured to capture the same view, or to capture different views. For example, the video camera 220 may be forward facing to capture at least a portion of the real-world view perceived by the user. This forward facing image captured by the video camera 120 may then be used to generate an augmented reality where computer generated images appear to interact with the real-world view perceived by the user.

The sensor 222 is shown mounted on the extending side-arm 216 of the eyeglasses 202; however, the sensor 222 may be provided on other parts of the eyeglasses 202. The sensor 222 may include one or more of a gyroscope or an accelerometer, for example. Other sensing devices may be included within the sensor 222 or other sensing functions may be performed by the sensor 222.

The finger-operable touch pads 224, 226 are shown mounted on the extending side-arms 214, 216 of the eyeglasses 202. Each of finger-operable touch pads 224, 226 may be used by a user to input commands. The finger-operable touch pads 224, 226 may sense at least one of a position and a movement of a finger via capacitive sensing, resistance sensing, or a surface acoustic wave process, among other possibilities. The finger-operable touch pads 224, 226 may be capable of sensing finger movement in a direction parallel or planar to the pad surface, in a direction normal to the pad surface, or both, and may also be capable of sensing a level of pressure applied. The finger-operable touch pads 224, 226 may be formed of one or more translucent or transparent insulating layers and one or more translucent or transparent conducting layers. Edges of the finger-operable touch pads 224, 226 may be formed to have a raised, indented, or roughened surface, so as to provide tactile feedback to a user when the user's finger reaches the edge of the finger-operable touch pads 224, 226. Each of the finger-operable touch pads 224, 226 may be operated independently, and may provide a different function.

FIG. 3 illustrates an alternate view of the device 200 of FIG. 2. As shown in FIG. 3, the lens elements 210 and 212 may act as display elements. The eyeglasses 202 may include a first projector 228 coupled to an inside surface of the extending side-arm 216 and configured to project a display 230 onto an inside surface of the lens element 212. Additionally or alternatively, a second projector 232 may be coupled to an inside surface of the extending side-arm 214 and configured to project a display 234 onto an inside surface of the lens element 210.

The lens elements 210 and 212 may act as a combiner in a light projection system and may include a coating that reflects the light projected onto them from the projectors 228 and 232. In some embodiments, a special coating may not be used (e.g., when the projectors 228 and 232 are scanning laser devices).

In alternative embodiments, other types of display elements may also be used. For example, the lens elements 210, 212 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 204 and 206 for driving such a matrix display. Alternatively or additionally, a laser or LED source and scanning system could be used to draw a raster display directly onto the retina of one or more of the user's eyes. Other possibilities exist as well.

2. Example Embodiments of Display Methods

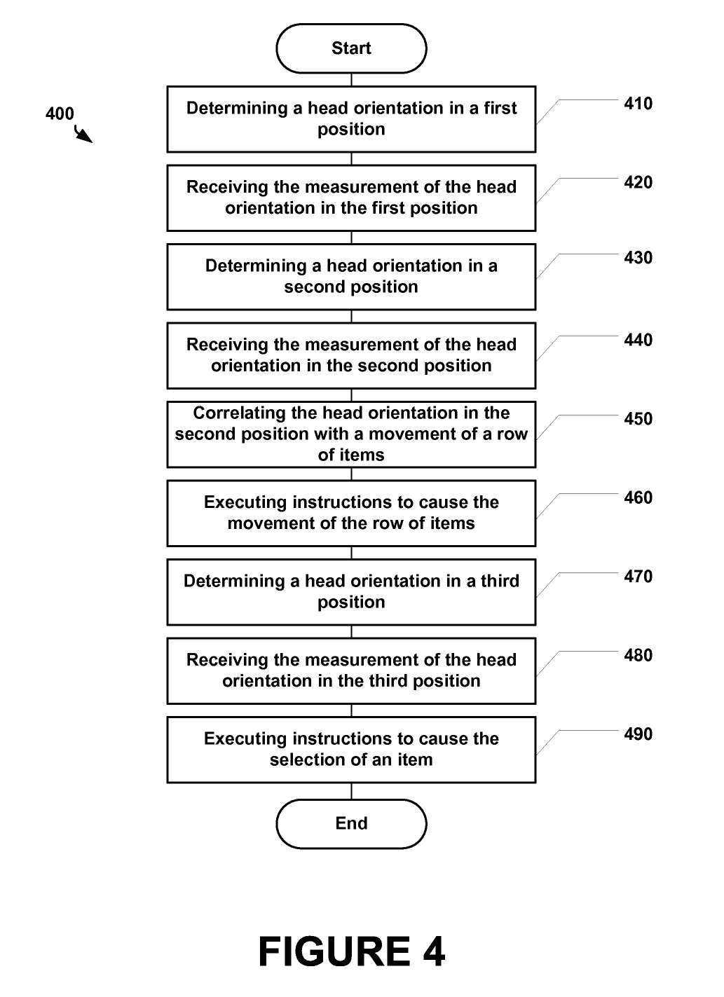

FIG. 4 is a flowchart of an illustrative method 400 for communicating a user's head movement with a user interface in accordance with one aspect of the present application. Method 400 shown in FIG. 4 presents an embodiment of a method that, for example, could be used with systems 100 and 150. Method 400 may include one or more operations, functions, or actions as illustrated by one or more of blocks 410-490. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

In addition, for the method 400 and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. The computer readable medium may include a non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

In addition, for the method 400 and other processes and methods disclosed herein, each block in FIG. 4 may represent circuitry that is wired to perform the specific logical functions in the process.

Initially, the method 400 includes determining a head orientation in a first position, at block 410. A sensor can be configured to make the determination. The sensor may be a gyroscope which is configured to measure a user's head orientation. The gyroscope may be mounted on the user's head in a variety of configurations, and may be part of a device as previously described with reference to FIG. 1C and FIGS. 2-3. For example, the gyroscope may be on a pair of goggles or glasses that the user wears.

The method 400 then includes receiving the measurement of the head orientation in the first position, at block 420.

The method 400 includes determining a head orientation in a second position, at block 430. A user may make a movement, such as moving his or her head. As an example, a user may tilt his or her head from the first position to a second position. In one example, the direction of the tilt of the head is such that the user's ear moves toward the user's shoulder. As previously discussed, a sensor can be configured to make the determination of head orientation. The sensor may be configured to determine a measurement of the user's head if the user tilts to a particular side, such as tilting toward the user's right shoulder, for example. In alternative embodiments, however, the sensor may be configured to determine a measurement of the user's head position when the head is tilted in either direction, such that a measurement can be taken when the user tilts his or her head either toward the left shoulder or toward the right shoulder.

The method 400 includes receiving the measurement of the head orientation in the second position, at block 440. A computing device, such as the computing devices 102 or 152 of FIGS. 1A and 1B, for example, may receive this indication of head movement.

The method 400 includes correlating the head orientation in the second position with a movement of a row of items; this is shown at block 450. A processor within the computing device may be configured to process the orientation data and perform the correlation. The correlation may be based on a comparison of the second measurement to the first measurement, such that the amount by which the row of items are determined to be moved is determined based on the difference between the first measurement and the second measurement.

Following, the processor may be configured to execute instructions to cause the movement of the row of items, at block 460. The processor may be configured to execute instructions to cause the movement of the row of items in the same direction of the head orientation so as to correlate the head orientation with the row of items.

The correlation may be that the tilt of the user's head, regardless of the degree of tilt, will result in the row of items shifting by a pre-determined number of items or by a predetermined distance. In this embodiment, the precise orientation of the user's head in the second position is not taken into account.

In an alternative embodiment, the correlation may be such that the degree of head tilt is correlated with the number of items that shift in the row. Then, within the processor various degrees of tilt may be assigned to the number of items that shift. As a result, if the user tilts his or her head by a certain degree, the processor will determine how many items in the row of items should be shifted based on that particular degree or head position. In this embodiment, ranges of degrees of head tilt or of head positions may be assigned to certain numbers of items by which to shift the row of items. A table may be provided that correlates certain degrees of head tilt or of head orientations with the number of items by which to shift the row of items.

In addition, the processor can be configured to use data regarding the user's head orientation to determine the number of degrees by which to rotate the user interface.

Furthermore, one of the items in the row of items may be highlighted on the user interface. The highlighting function can be configured to highlight items that are present in a particular location on the interface. When the items in the row shift, a new item may be highlighted as that new item has moved into the highlighted location. The previously highlighted item, which has moved as well in the shift, is no longer in the highlighted location, and thus is no longer highlighted.

In one example, if a user wants to select a highlighted item, the user can nod his or her head (e.g., a downward movement of the user's head wherein the user's chin moves toward the user's neck) such that the head moves into a third position. Other head movements may be contemplated to select an item, such as a user shaking his or her head, for example. The method 400 then includes determining a head orientation in the third position, at block 470.

The method 400 includes receiving the measurement of the head orientation in the third position, at block 480. As previously stated, a computing device, such as the computing devices 102 or 152 of FIGS. 1A and 1B, for example, may receive this indication of head movement.

Next, the method 400 includes executing instructions to cause the selection of an item, shown at block 490.

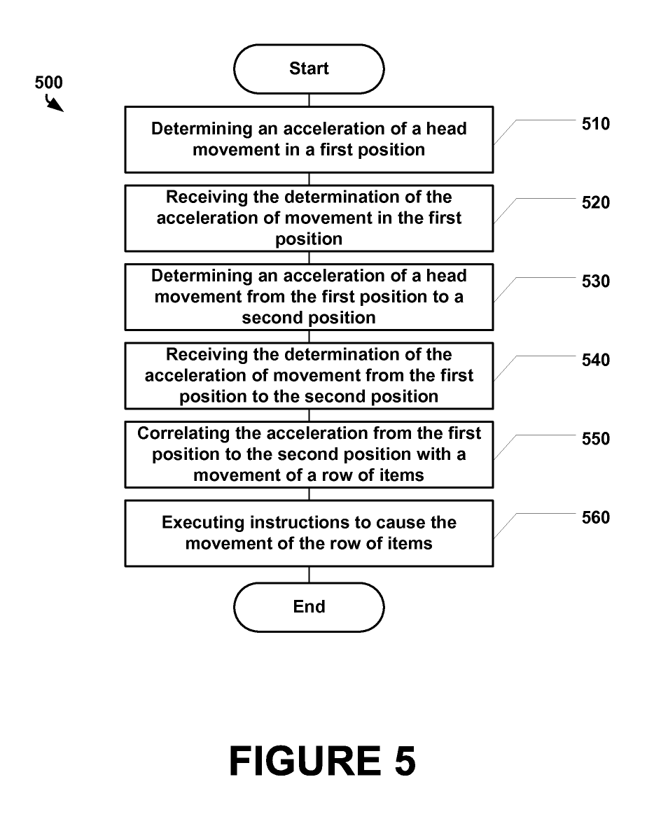

FIG. 5 is a flowchart of an illustrative method 500 for communicating a user's head movement with a user interface in accordance with one aspect of the application. Method 500 shown in FIG. 5 presents an embodiment of a method that, for example, could be used with systems 100 and 150. Method 500 may include one or more operations, functions, or actions as illustrated by one or more of blocks 510-560. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation.

Initially, the method 500 includes determining an acceleration of a head movement in a first position, at block 510. For example, an instrument, such as an accelerometer, may be used to determine the acceleration of motion of the user's head. At block 510, the acceleration is likely negligible as it is assumed the user has not yet tilted or otherwise moved his or her head. The accelerometer may be mounted on the user's head in a variety of configurations, and may be part of a device as previously described with reference to the sensors of FIG. 1C and FIGS. 2-3.

The method 500 includes receiving the determination of the acceleration of movement in the first position, at block 520.

The method then includes determining an acceleration of a head movement from the first position to a second position, at block 530. A user may make a movement, such as moving his or her head. As an example, a user may tilt his or her head from the first position to a second position. In one example, the direction of the tilt of the head is such that the user's ear moves toward the user's shoulder. The sensor may be configured to track the user's acceleration of movement as the user tilts his or her head.

The method includes receiving the determination of the acceleration of movement from the first position to the second position, at block 540.

The method includes correlating the determined acceleration from the first position to the second position with a movement of a row of items on a display, at block 550. A processor within the computing device may be configured to process the acceleration data and execute instructions to correlate the acceleration with the movement of the row of items. The correlation is such that, when the user's head orientation is in the first position and the acceleration is zero or negligible, the row of items is stationary.

Following, the method includes executing instructions to cause the movement of the row of items, at block 560. For example, a processor can execute instructions to cause items displayed on a user interface in row of items to shift at a rate comparable to the acceleration that was determined at block 530.

In an alternative embodiment, both a gyroscope and an accelerometer may be present, such that the gyroscope determines various head orientations and an accelerometer determines various accelerations of head movements. A computing device, such as the computing devices discussed with reference to FIGS. 1A and 1B, can be configured to receive the determinations and execute instructions to correlate the movement of a row of items with the determinations, as recited in FIG. 4 and FIG. 5. The computing device can also be configured to execute instructions to cause the movement of the row of items, and a selection of an item, as discussed with respect to FIG. 4, and to cause the movement to occur at an acceleration comparable to the determined acceleration, as discussed with respect to FIG. 5. Thus, the methods of FIG. 4 and FIG. 5 can be combined when both a gyroscope and an accelerometer are present in an embodiment.

3. Example Display of Items on a User Interface

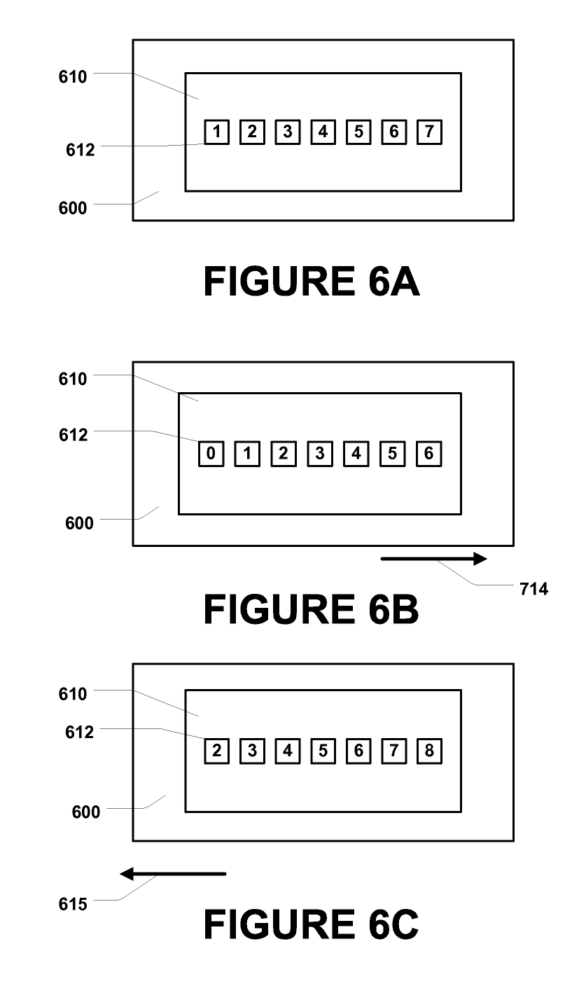

FIG. 6A is an example user interface of a device 600 in a first position. In one embodiment, the device 600 may be a wearable item, such as a pair of goggles or glasses, on which the user interface 610 is displayed. For example, device 600 may be a device such as described with reference to FIGS. 1C and 2-3. In an alternative embodiment, user interface 610 may be projected onto a separate screen, and thus the user interface 610 may not be present on any device wearable by the user.

A plurality of items 612 may be present on the user interface 610, and the items 612 can be displayed in a row. Seven items 612 are shown in FIG. 6A, but any number of items may be displayed on user interface 610. Items 612 are numbered 1-7; this numbering is merely to show how the items move from their positions in FIG. 6A to their positions in FIG. 6B. Items 612 may correspond to application icons, such that if a user selects a particular icon, an application represented by that icon will appear on user interface 610. When an icon is selected, instructions are executed by a processor to perform functions that include running a program or displaying an application.

FIG. 6A illustrates the user interface 610 before a processor of the device has executed instructions to cause the items 612 to shift, such as, for example, before block 460 in FIG. 4 or block 560 in FIG. 5.

FIG. 6B is the example user interface of the device of FIG. 6A in a second position. In FIG. 6B, the user interface 610 is shown after the processor has executed instructions to cause the items 612 to shift or move, such as, for example, as in block 460 in FIG. 4 or block 560 in FIG. 5. In FIG. 6B, items 612 have shifted by one item in the direction of arrow 614, or to the right. Thus, instead of the item 612 labeled “1” being the left-most item visible on the user interface 610, a new item 612 appears, labeled “0”. Similarly, the item 612 labeled “7” no longer appears on user interface 612 as it has shifted to the right and off the user interface 610, so item 612 labeled “6” is now the last viewable item on user interface 610.

In the embodiment shown in FIG. 6B, to the user it appears that the row of items 612 has moved in the direction of the user's head orientation (in this scenario the user's head is tilted to the right).

FIG. 6C is the example user interface of the device of FIG. 6A in an exemplary alternative second position. FIG. 6C illustrates an embodiment in which the display appears to a user to move in correspondence with the user's head movement, instead of the row of items moving. In the example shown in FIG. 6C, the user interface 610 is shown after the processor has executed instructions to cause the items 612 to shift or move, such as, for example, as in block 460 in FIG. 4 or block 560 in FIG. 5. In FIG. 6C, items 612 have shifted by one item in the direction of arrow 615, or to the left. Thus, instead of the item 612 labeled “1” being the left-most item visible on the user interface 610, item 612 labeled “2” is now the left-most item visible. Item 612 labeled “1” no longer appears on user interface 612 as it has shifted to the left and off the user interface 610. Similarly, the item 612 labeled “7” is no longer the right-most item visible, a new item 612 labeled “8” has appeared on the interface 610 and is now the right-most visible item. In this embodiment, to the user it appears that the screen has moved in the direction of the user's head orientation (in this scenario the user's head is tilted to the right) instead of the row of items 612.

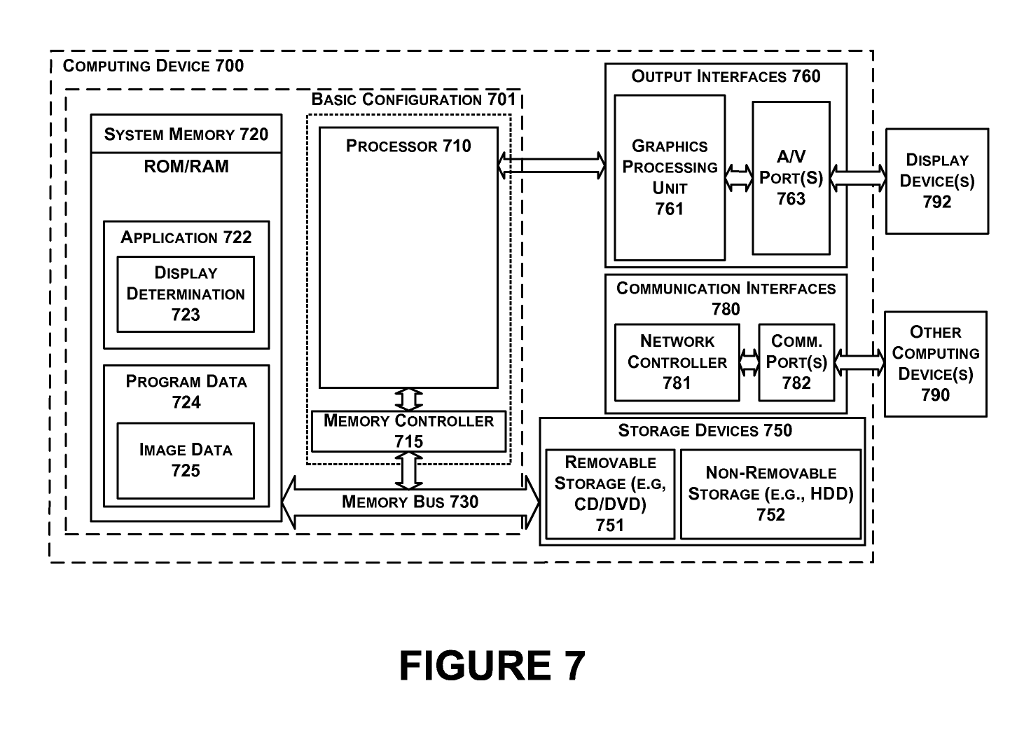

FIG. 7 is a functional block diagram illustrating an example computing device used in a computing system that is arranged in accordance with at least some embodiments described herein. The computing device may be a personal computer, mobile device, cellular phone, video game system, or global positioning system. In a very basic configuration 701, computing device 700 may typically include one or more processors 710 and system memory 720. A memory bus 730 can be used for communicating between the processor 710 and the system memory 720. Depending on the desired configuration, processor 710 can be of any type including but not limited to a microprocessor (μP), a microcontroller (μC), a digital signal processor (DSP), or any combination thereof. A memory controller 715 can also be used with the processor 710, or in some implementations, the memory controller 715 can be an internal part of the processor 710.

Depending on the desired configuration, the system memory 720 can be of any type including but not limited to volatile memory (such as RAM), non-volatile memory (such as ROM, flash memory, etc.) or any combination thereof. System memory 720 typically includes one or more applications 722, and program data 724. Application 722 may include a display determination 723 that is arranged to provide inputs to the electronic circuits, in accordance with the present disclosure. Program data 724 may include image data 725 that could provide image data to the electronic circuits. In some example embodiments, application 722 can be arranged to operate with program data 724 on an operating system 721. This described basic configuration is illustrated in FIG. 7 by those components within dashed line 701.

Computing device 700 can have additional features or functionality, and additional interfaces to facilitate communications between the basic configuration 701 and any devices and interfaces. For example, the data storage devices 750 can be removable storage devices 751, non-removable storage devices 752, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Computer storage media can include volatile and nonvolatile, removable and non-removable media implemented in any method or technology for storage of information, such as computer readable instructions, data structures, program modules, or other data.

System memory 720, removable storage 751, and non-removable storage 752 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media can be part of device 700.

Computing device 700 can also include output interfaces 760 that may include a graphics processing unit 761, which can be configured to communicate to various external devices such as display devices 792 or speakers via one or more A/V ports 763 or a communication interface 780. A communication interface 780 may include a network controller 781, which can be arranged to facilitate communications with one or more other computing devices 790 over a network communication via one or more communication ports 782. The communication connection is one example of a communication media. Communication media may typically be embodied by computer readable instructions, data structures, program modules, or other data in a modulated data signal, such as a carrier wave or other transport mechanism, and includes any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media. The term computer readable media as used herein can include both storage media and communication media.

Computing device 700 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 can also be implemented as a personal computer including both laptop computer and non-laptop computer configurations.

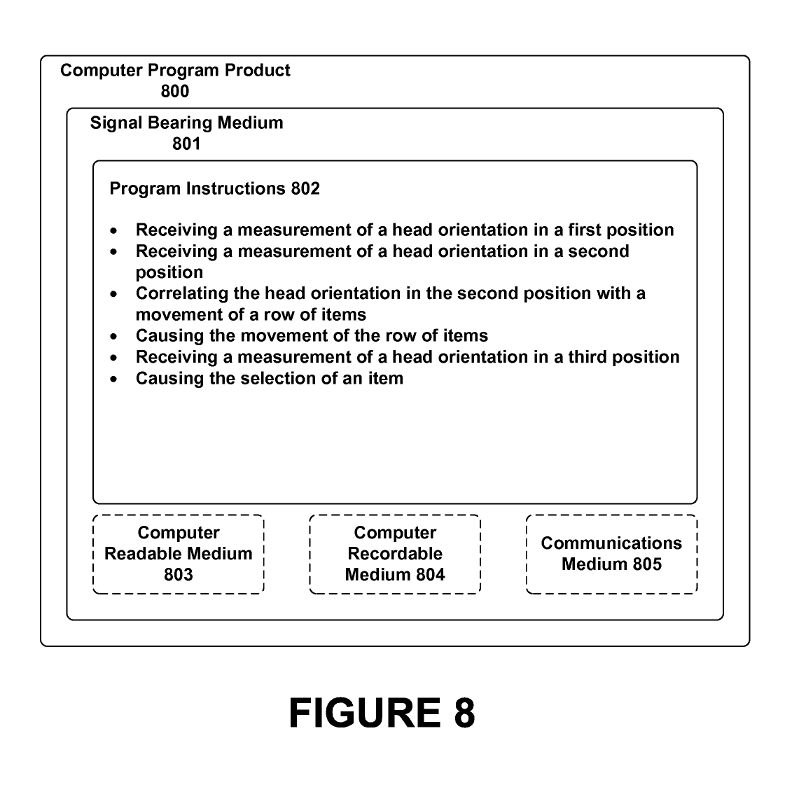

In some embodiments, the disclosed methods may be implemented as computer program instructions encoded on a computer-readable storage media in a machine-readable format. FIG. 8 is a schematic illustrating a conceptual partial view of an example computer program product 800 that includes a computer program for executing a computer process on a computing device, arranged according to at least some embodiments presented herein. In one embodiment, the example computer program product 800 is provided using a signal bearing medium 801. The signal bearing medium 801 may include one or more programming instructions 802 that, when executed by one or more processors may provide functionality or portions of the functionality described above with respect to FIGS. 1-7. Thus, for example, referring the embodiment shown in FIGS. 4 and 5, one or more features of blocks 400-495 and 500-595 may be undertaken by one or more instructions associated with the signal bearing medium 801.

In some examples, the signal bearing medium 801 may encompass a computer-readable medium 803, such as, but not limited to, a hard disk drive, a Compact Disc (CD), a Digital Video Disk (DVD), a digital tape, memory, etc. In some implementations, the signal bearing medium 801 may encompass a computer recordable medium 804, such as, but not limited to, memory, read/write (R/W) CDs, R/W DVDs, etc. In some implementations, the signal bearing medium 801 may encompass a communications medium 805, such as, but not limited to, a digital and/or an analog communication medium (e.g., a fiber optic cable, a waveguide, a wired communications link, a wireless communication link, etc.). Thus, for example, the signal bearing medium 801 may be conveyed by a wireless form of the communications medium 805 (e.g., a wireless communications medium conforming with the IEEE 802.11 standard or other transmission protocol).

The one or more programming instructions 802 may be, for example, computer executable and/or logic implemented instructions. In some examples, a computing device such as the computing device 700 of FIG. 7 may be configured to provide various operations, functions, or actions in response to the programming instructions 802 conveyed to the computing device 700 by one or more of the computer readable medium 803, the computer recordable medium 804, and/or the communications medium 805.

In some examples, the above-described embodiments enable a user to communicate hands-free with a user interface, thus providing the user with the freedom of not juggling typing on a device with other tasks, as well as the ability to gather and communicate information in a more natural manner.

It should be further understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

1. A method for correlating a head movement with a list of items displayed on a user interface, the method comprising:
receiving a first measurement indicating a first orientation of a user's head;
receiving a second measurement indicating a second orientation of the user's head;
determining a movement of at least one item on a user interface based on the second measurement; and
causing the at least one item to move based on the determination.

2. The method of claim 1, wherein the user interface is on a heads up display.

3. The method of claim 1, further comprising comparing the second measurement to the first measurement and determining the movement of the at least one item based on a difference between the first measurement and the second measurement.

4. The method of claim 1, further comprising executing instructions to rotate the user interface in accordance with the second measurement.

5. The method of claim 1, wherein receiving a second measurement indicating the second orientation of a user's head is receiving a measurement indicating a tilt of the user's head, such that a user's ear on a side moves toward a user's shoulder on the same side.

6. The method of claim 1, wherein causing the at least one item to move comprises moving each item in a row of items.

7. The method of claim 1, further comprising receiving the first measurement and the second measurement from a gyroscope.

8. The method of claim 1, further comprising receiving an acceleration of a user's head movement as the user's head moves from the first orientation to the second orientation from an accelerometer.

9. The method of claim 8, further comprising:
receiving the measurement of the acceleration of the user's head movement;
determining an acceleration of a movement of the at least one item on the user interface based on the measurement of the acceleration of the user's head movement; and
causing the at least one item to move at the determined acceleration.

10. The method of claim 8, wherein causing the at least one item to move comprises shifting the at least one item based on a difference between the first measurement and the second measurement.

11. The method of claim 1, wherein causing the at least one item to move based on the determination comprises shifting the at least one item in a row of items in a direction, wherein the direction is in accordance with the second orientation.

12. The method of claim 1, wherein causing the at least one item to move based on the determination comprises moving each item in a row of items to the left.

13. The method of claim 11, further comprising:
receiving a third measurement indicating a third orientation of a user's head;
determining a selection of a given item on the user interface based on the third measurement; and
causing the given item to be selected.

14. An article of manufacture including a tangible computer-readable media having computer-readable instructions encoded thereon, the instructions comprising:
receiving a first measurement indicating a first orientation of a user's head;
receiving a second measurement indicating a second orientation of the user's head;
determining a movement of at least one item in a row of items displayed on a user interface based on a received measurement indicating the second orientation of the user's head; and
causing the at least one item to move in accordance with the determination.

15. The article of manufacture of claim 14, wherein the article of manufacture is a heads up display device.

16. The article of manufacture of claim 14, wherein the instructions further comprise instructions for receiving the first orientation and the second orientation of the user's head from a gyroscope.

17. The article of manufacture of claim 14, the instructions further comprising:
receiving an acceleration of a user's head movement as the user's head moves from the first orientation to the second orientation from an accelerometer.

18. The article of manufacture of claim 17, the instructions further comprising:
receiving the measurement of the acceleration of the user's head movement;
determining an acceleration of the movement of the at least one item on the user interface based on the measurement of the acceleration of the user's head movement; and
causing the at least one item to move at an acceleration comparable to the determined acceleration.

19. The article of manufacture of claim 14, wherein the instructions of causing the at least one item to move in accordance with the determination comprises shifting the at least one item in a row of items in a direction, wherein the direction is in accordance with the orientation.

20. A system comprising:
a processor;
at least one sensor;
data storage; and
machine language instructions stored on the data storage executable by the processor to perform functions including:
receiving a first measurement from the at least one sensor indicating a first orientation of a user's head;
receiving a second measurement from the at least one sensor indicating a second orientation of a user's head;
determining a movement of at least one item displayed in a list on a user interface based on the second measurement; and
causing the at least one item to move in accordance with the determination.

21-22. (canceled)

23. The system of claim 19, wherein the user interface is present on a heads up display device.

24. The system of claim 19, wherein the at least one sensor comprises a gyroscope and an accelerometer, and wherein the instructions further comprise:
using the accelerometer to obtain a measurement of an acceleration of a user's head movement as the user's head moves from the first orientation to the second orientation;
receiving the measurement of the acceleration of the user's head movement;
determining an acceleration of the movement of the at least one item displayed on the user interface based on the measurement of the acceleration of the user's head movement; and
causing the at least one item to move at the determined acceleration.
